(19) United States
(12) Patent Application Publication
(10) Pub. No.: US 2004/0207128 A1
(43) Pub. Date: Oct. 21, 2004

(54) Method for producing a container provided with a screw cap assembly

(76) Inventor: Ake Rosen, Rydeback (SE)

Correspondence Address: BIRCH STEWART KOLASCH & BIRCH, PO BOX 747, FALLS CHURCH, VA, 22040-0747, US

(21) Appl. No.: 10/482,964

(22) PCT Filed: Aug. 21, 2002
(86) PCT No.: PCT/SE02/01500

(30) Foreign Application Priority Data
Aug. 22, 2001 (SE) 0102788-7

(51) Int. Cl. B29C 51/00; B29C 51/10

(52) U.S. Cl. 264/544; 264/553

(57) ABSTRACT

A method for producing a container (19) provided with a screw cap assembly. The method is characterised by the steps of arranging a screw cap (11) provided with an internal thread (12) relative to a heated wall portion (18) of a body (1) of the container (19) in such manner that an opening (15) of the screw cap (11) is applied to and thus covered by the wall portion (18), and thermo-forming in said wall portion (18) a projection (17) provided with an external thread, said screw cap (11) acting as a mould.

### FIELD OF THE INVENTION

The present invention relates to a method for producing a container provided with a screw cap assembly.

### BACKGROUND ART

Containers of this type can be produced in a number of different ways, for instance by blow moulding or thermoforming.

In particular it is possible to produce such containers of a material comprising a core layer with a filler of mineral material and a binder of polyolefin material. Such containers are advantageous, among other things since they are inexpensive to produce while they can be made to have a good rigidity even with a relatively small material thickness.

In many cases it is advantageous to provide the container with an opening means in the form of a screw cap assembly. In the case with blow-moulded containers, this is relative easy to accomplish. The mould in which the container is blow moulded can, for instance, have a portion which forms an externally threaded projection of the container during the blow moulding process, to which projection a complementarily designed screw cap is connectable. If a screw cap assembly is required for a thermoformed container, it is, however, necessary for a separate screw cap assembly to be connected to the container in a suitable manner. This is a fairly complicated and expensive method, and therefore thermoformed containers usually have no screw cap assembly. It will be appreciated that containers comprising a screw cap assembly are advantageous since the containers will be resealable.

There is thus a need for an improved method of producing thermoformed containers comprising a screw cap assembly.

### SUMMARY OF THE INVENTION

In view of the above, a first object of the present invention is to provide an improved method for producing a container provided with a screw cap assembly.

A second object is to provide a method which in a cost-effective manner allows production of such containers.

According to the present invention, these objects and also other objects that will be evident from the following description will be achieved by a method having the features stated in claim 1. Preferred embodiments of the method are evident from claims 2-8.

More specifically, according to the present invention a method is provided for producing a container provided with a screw cap assembly, said method being characterised by the steps of arranging a screw cap provided with an internal thread relative to a heated wall portion of a body of the container in such manner that an opening of the screw cap is applied to and thus covered by the wall portion, and thermoforming in said wall portion a projection provided with an external thread, said screw cap acting as a mould.

This results in a method which easily allows production of a container with a screw cap assembly. The container is provided with a screw cap assembly by thermoforming of an externally threaded projection in a heated wall portion of the container, a screw cap acting as a mould. A threaded projection, with which the screw cap engages, is thus provided in an extremely quick and simple manner.

According to a preferred embodiment of the method, the step of thermoforming said projection is carried out integrally with the step of thermoforming the body of the container. The body of the container is preferably thermoformed in a forming means with a hole in which the screw cap is arranged. Advantageously the body of the container and the projection produced integrally therewith are thermoformed by a pneumatic forming operation, in which a heated web- or sheet-shaped body material is pressed by means of air into a forming means, whereby said air also presses said wall portion into the screw cap to form said projection.

According to one more preferred embodiment of the inventive method, the step of thermoforming said projection is preceded by the steps of filling the body of the container with contents and sealing the body. Preferably the projection is thermoformed by a pneumatic forming operation, in which the heated wall portion is inserted into the screw cap to form said projection. This is advantageously achieved by evacuation of air from the screw cap via throughgoing suction ducts, whereby a sub-atmospheric pressure is generated in the screw cap and sucks the wall portion into the same.

The body of the container is advantageously made of a material with a core layer comprising a filler of mineral material and a binder of polyolefin. The material of which the body of the container is made results in a container which is rigid even at a relatively small wall thickness.

Preferred embodiments of the present invention will now be described by way of example and with reference to the accompanying drawings.

### BRIEF DESCRIPTION OF THE DRAWINGS

FIG. 1 is a schematic view of a first preferred inventive method for producing a container provided with a screw cap assembly.

FIGS. 2-5 illustrate schematically a second preferred inventive method for producing a container provided with a screw cap assembly.

### DESCRIPTION OF EMBODIMENTS

According to the present invention, a method is provided for producing a container provided with a screw cap assembly.

The container may comprise a thermoformed body, which after filling with suitable contents is sealed by applying a sealing means over an open bottom side of the body. This sealing means then forms a bottom of the container. Subsequently some different preferred embodiments of the inventive method will be described with reference to containers of the type described above, equivalent components being given the same reference numerals. It will be appreciated, however, that the container can be designed in other manners.

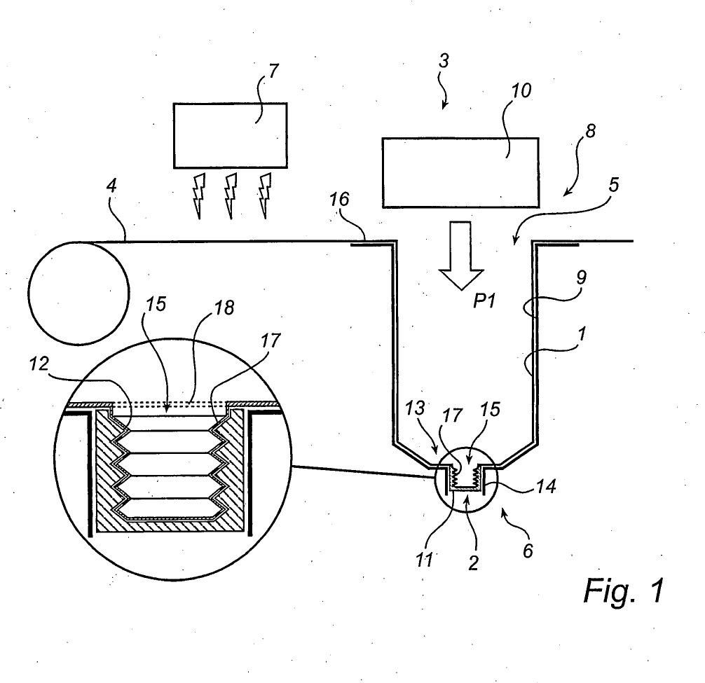

FIG. 1, to which reference is now made, illustrates the method for producing such a body 1 of a container (not shown), a screw cap assembly 2 being arranged on the body 1 in connection with the thermoforming thereof according to a first preferred embodiment of the present invention.

The Figure shows how the body 1 is thermoformed at a thermoforming station 3 from a web-shaped material 4 in a roll. It will be appreciated that the web-shaped material 4 can be supplied in other ways, for instance by extrusion. The material can also be supplied in sheets.

The web-shaped material 4 comprises a core layer, which in turn contains a filler of mineral material and a binder of polyolefin material. Preferred mineral materials are chalk, talc and/or mica. This allows production of inexpensive as well as environment-friendly containers which even at small wall thicknesses have the necessary rigidity.

The thermoformed body 1 is of an essentially cylindrical form, but it will be appreciated that the body 1 is preferably given a somewhat conical shape in order to facilitate the subsequent removal of the body 1 from the thermoforming station 3. The body 1 further has an open bottom side 5 and a side 6 which is opposite to the bottom side 5 and at which the screw cap assembly 2 is arranged.

In order to produce said body 1, the web-shaped material 4 is thus supplied to the thermoforming station 3 via a heating station 7, at which the web-shaped material 4 is heated (which is indicated by means of flash-type arrows) up to a temperature that is required for thermoforming.

The thermoforming station 3 comprises a forming means 8 with a cavity 9 and a thermoforming means 10.

The cavity 9 has an inner shape corresponding to the outer shape of the completed body 1. A screw cap 11 with an internal thread 12 is inserted in the bottom 13 of the cavity 9. The cavity 9 has in said bottom 13 a hole 14, in which the screw cap 11 is arranged with its opening 15 directed towards the cavity 9.

Thus the web-shaped material 4 is supplied in its heated state to the thermoforming station 3 in such manner that part thereof covers the cavity 9 of the forming means 8.

Then the thermoforming means 10 is actuated for thermoforming of the body 1. According to the shown embodiment, the thermoforming is carried out by a pneumatic forming operation, which is carried out by applying a pressure above atmospheric to the side 16 of the web-shaped material 4 facing away from the cavity 9. As a result, part of the web-shaped material 4 is pressed into the cavity 9 which is indicated by the arrow P1. It will be appreciated that the thermoforming can also be assisted by a stamping means (not shown) which mechanically moves the web-shaped material 4 into the cavity 9.

In connection with the thermoforming of the body 1, an externally threaded projection 17 of the body 1 is simultaneously thermoformed, the screw cap 11 acting as a mould, which is clearly to be seen in the broken-away enlargement of a detail in FIG. 1.

A heated wall portion 18 of the body 1 will be applied to and thus also cover the opening 15 of the screw cap 11 (indicated by means of dashed lines). Then the air will press the heated wall portion 18 into the screw cap 11, the wall portion 18 assuming the shape of the externally threaded projection 17. Said projection 17 will be sealed. It will be appreciated that the projection 17 can be open by a user in connection with the first opening of the completed container. Alternatively, it is possible to open the projection 17 in an operation immediately after thermoforming. For instance, it is possible to insert a means into the body 1 for punching a portion in the side of the projection 17 facing away from the body. This portion can later be removed or welded to the screw cap 11.

The thermoformed body 1 can be released from the rest of the web-shaped material 4 in connection with the thermoforming thereof or in a subsequent operation.

Thus, a body 1 provided with a screw cap assembly 2 is accomplished in an extremely simple manner. As mentioned above, the body 1 can then be filled with contents to be finally sealed by applying a sealing means (not shown) over the open bottom side 5 of the body 1.

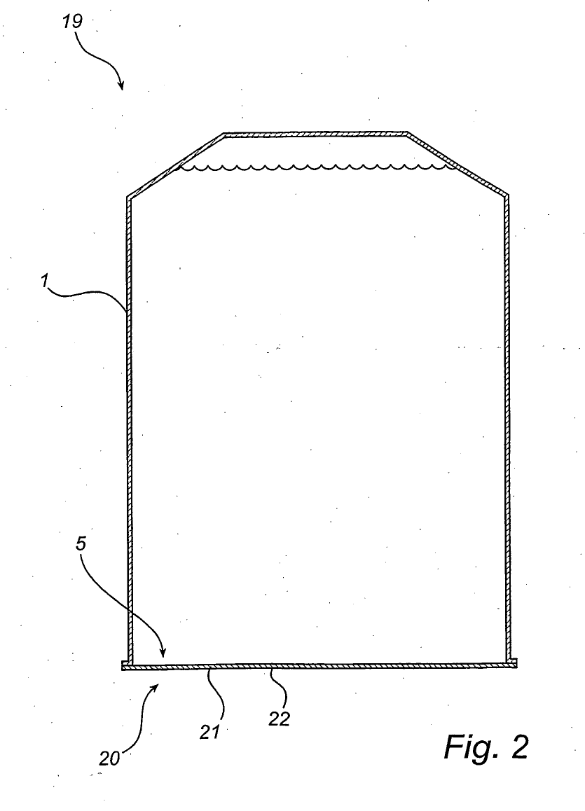

FIGS. 2-5, to which reference is now made, illustrate the method for producing a container 19 provided with a screw cap assembly 2, the screw cap assembly 2 being arranged on the container 19 in its filled and sealed state according to a second preferred embodiment of the present invention.

The container 19 comprises a thermoformed body 1 and a sealing means 20 applied over an open bottom side 5 of the body.

The sealing means 20 consists of a wafer 21, which is applied over said bottom side 5 after filling of the body with suitable contents, said wafer 21 forming a bottom 22 of the container 19.

As is evident form FIG. 2, the container 19 does not comprise a screw cap assembly 2 in its state immediately after filling and sealing.

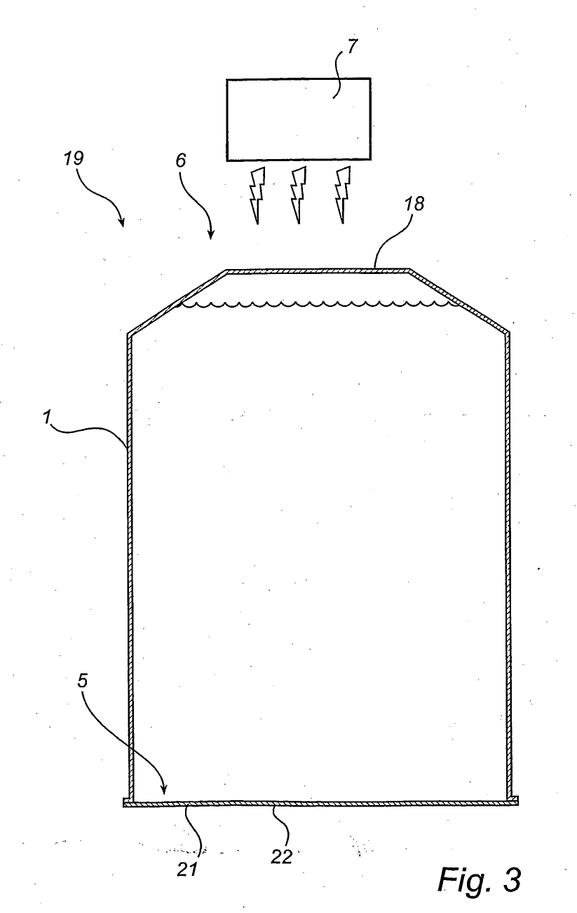

In order to provide the container 19 with such a screw cap assembly 2, a wall portion 18 of the body 1 of the container 19 is first heated at a heating station 7 to a temperature as required for thermoforming, which is indicated in FIG. 3 by means of flash-type arrows. This wall portion 18 is according to the shown embodiment located at a side 6 opposite to the bottom side 5 of the body 1. This side 6 thus forms the upper side of the container 19 while said wafer 21 forms the bottom 22 of the container 19.

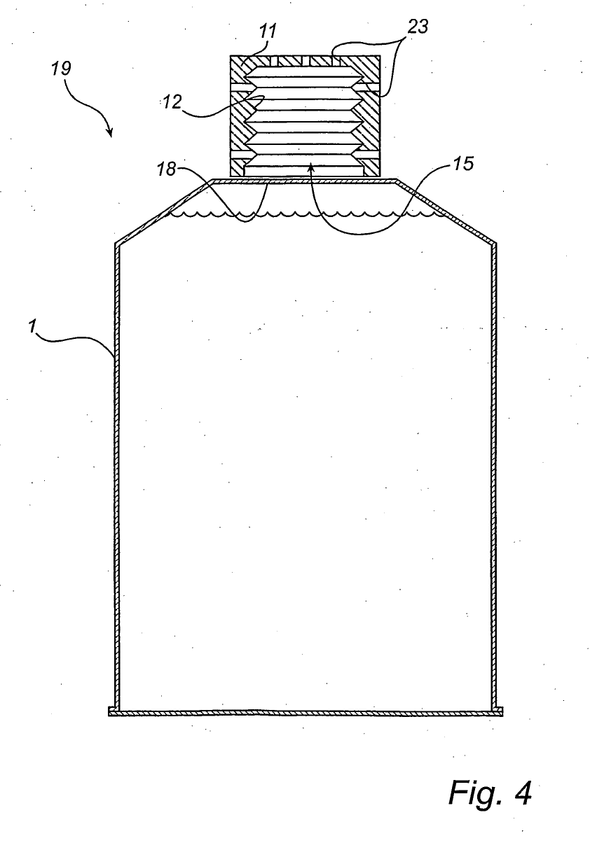

FIG. 4 illustrates how an internally threaded screw cap 11 is applied to the container 19 with its opening 15 facing the heated wall portion 18 in such a manner that the opening 15 is covered by said wall portion 18. As is evident from the Figure, the screw cap 11 has a number of through going suction ducts 23.

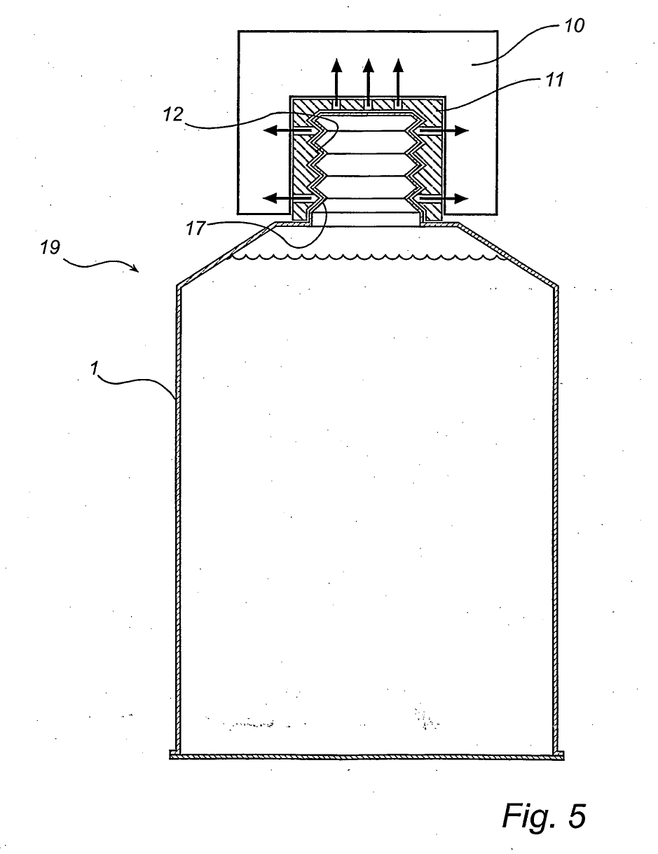

FIG. 5 shows how a thermoforming means 18 is applied round the screw cap 11. The thermoforming means 10 is arranged for pneumatic thermoforming of an externally threaded projection 17 on the body 1 of the container 19, the screw cap 11 acting as a mould.

The thermoforming means 10 is adapted to evacuate air from the interior of the screw cap 11 via said suction ducts 23 for generating a subatmospheric pressure, which sucks the heated wall portion 18 into the screw cap 11. The wall portion 18 will be made to abut against the internal thread 12 of the screw cap 11 and then assume the shape of an externally threaded projection 17.

The throughgoing suction ducts 23 of the screw cap 11 are advantageously sealed in a subsequent operation.

The above described second preferred embodiment of the inventive method for producing a container 19 provided with a screw cap assembly 2 thus allows application of the screw cap assembly 2 to the container 19 when this has already been filled and sealed. It should be noted that the seal of the container 19 is not broken when applying the screw cap assembly 2.

According to the present invention, a method is thus provided, which allows simple and also inexpensive production of a container provided with a screw cap assembly. The assembly is applied more specifically to the container by heating of a wall portion of its body, to which wall portion a screw cap is later applied, after which an externally threaded projection is thermoformed on the container, the screw cap acting as a mould. The screw cap assembly can be applied to the container during production thereof or after it has been filled with contents and then sealed.

It will be appreciated that the present invention is not restricted to the embodiments described. Several variants and modifications are feasible, which means that the scope of the invention is exclusively defined by the appended claims.

1. A method for producing a container (19) provided with a screw cap assembly,
characterised by the steps of
arranging a screw cap (11) provided with an internal thread (12) relative to a heated wall portion (18) of a body (1) of the container in such manner that an opening (15) of the screw cap (11) is applied to and thus covered by the wall portion (18), and
thermoforming in said wall portion (18) a projection (17) provided with an external thread, said screw cap (11) acting as a mould,
wherein the step of thermoforming said projection (17) is carried out integrally with the step of thermoforming the body (1) of the container (19).

2. A method as claimed in claim 1, wherein the step of thermoforming the body (1) is carried out in a forming means (8) with a hole (14), in which said screw cap (11) is arranged.

3. A method as claimed in claim 1 or 2, wherein the body (1) and the projection (17) which is produced integrally therewith are thermoformed by a pneumatic forming operation, in which a heated web- or sheet-shaped body material (4) is pressed by means of air into a forming means (8), whereby said air also presses said wall portion (18) into the screw cap (11) to form said projection (17).

4. A method for producing a container (19) provided with a screw cap assembly,
characterised by the steps of
arranging a screw cap (11) provided with an internal thread (12) relative to a heated wall portion (18) of a body (1) of the container in such manner that an opening (15) of the screw cap (11) is applied to and thus covered by the wall portion (18), and
thermoforming in said wall portion (18) a projection (17) provided with an external thread, said screw cap (11) acting as a mould,
wherein the step of thermoforming said projection (17) is preceded by the steps of filling the body (1) of the container (19) with contents and sealing the container (19).

5. A method as claimed in claim 4, wherein the projection (17) is thermoformed by a pneumatic forming operation, in which the heated wall portion (18) is inserted into the screw cap (11) to form said projection (17).

6. A method as claimed in claim 5, wherein the heated wall portion (18) is inserted into the screw cap (11) by evacuation of air from the screw cap (11) via throughgoing suction ducts (23), whereby a subatmospheric pressure is generated in the screw cap (11) and sucks the wall portion (18) into the same.

7. A method as claimed in claim 1, wherein said body (1) is made of a material (4) having a core layer comprising a filler of mineral material and a binder of polyolefin.
